(19) United States
(12) Patent Application Publication
(10) Pub. No.: US 2016/0367076 A1
(43) Pub. Date: Dec. 22, 2016

(54) BARBECUE GRILL

(71) Applicant: ELECTROLUX APPLIANCES AKTIEBOLAG, Stockholm (SE)

(72) Inventors: Roberto DORIGO, Porcia (IT); Omero TUZZI, Porcia (IT); Claudio CENEDESE, Porcia (IT)

(21) Appl. No.: 14/902,033

(22) PCT Filed: Jun. 26, 2014
(86) PCT No.: PCT/EP2014/063480

§ 371 Date: Dec. 30, 2015

(30) Foreign Application Priority Data
Jul. 1, 2013 (EP) 13174494.8

(51) Int. Cl. A47J 37/07

(52) U.S. Cl. CPC A47J 37/0709

(57) ABSTRACT

The barbecue grill includes a cooking compartment, a cooking surface located in the cooking compartment, and at least one heating element located under the cooking surface and operated to provide heat for cooking food placed on the cooking surface. The barbecue grill also includes at least one additional heating element to generate electromagnetic radiation in the microwave spectrum and feed the electromagnetic radiation into the cooking compartment for investing food placed on the coking surface.

The present invention generally relates to the field of cooking appliances. More specifically, the present invention relates to barbecue grill appliances, hereinafter simply referred to as “barbecue grills”.

Many known types of barbecue grills are available in the market, both for outdoor and indoor uses. Known barbecue grills typically have one or more heating elements and one or more cooking surfaces. The cooking surface is typically grill-shaped, for example comprising parallel metal bars or a porcelain-covered metal gridiron. The heating elements are typically located under the cooking surface, so as to allow food placed on the cooking surface to be cooked by providing heat directly from below. Such heating elements are designed to generate, when fed with a fuel or a source of energy and properly operated, intense heat, usually up to temperatures of 260° C. or more. Known heating elements may comprise supports for charcoal, gas burners, or electric heaters.

Known barbecue grills are affected by several drawbacks.

First of all, irrespective of the heating elements type, the cooking process is quite slow. This drawback is further exacerbated if the amount of food to be prepared cannot be cooked all at once, such as when a great number of guests have to be served. In this case, different portions of the whole amount of food have to be cooked in different sequential cooking steps; if each cooking step lasts too much, the food portions cooked earlier may excessively cool down.

Moreover, the cooking quality offered by known barbecue grills is not always satisfactory when large pieces of food (such as turkeys or big fishes) have to be cooked.

In view of the state of the art outlined in the above, Applicant has handled the problem of how to speed up the cooking process of, and improve the cooking quality offered by, barbecue grills.

Applicant has found that by feeding electromagnetic radiation in the microwave spectrum into the cooking compartment of a barbecue grill, the combination of heat produced by the heating elements of the barbecue grill and heat produced by such electromagnetic radiation allows to efficiently cook food in a fast way. Thanks to the action of the electromagnetic radiation in the microwave spectrum, which is able to deeply penetrate into the food to be cooked, it is possible to evenly heat also large piece of food, improving the cooking quality.

One aspect of the present invention proposes a barbecue grill comprising a cooking compartment, a cooking surface located in the cooking compartment, and at least one heating element located under the cooking surface and adapted to be operated to provide heat for cooking food placed on the coking surface. The barbecue grill further comprises at least one additional heating element adapted to generate electromagnetic radiation in the microwave spectrum and feed said electromagnetic radiation into the cooking compartment for investing food placed on the coking surface.

Preferably, the at least one heating element is adapted to generate heat from a solid fuel, a gas fuel or an electric current.

According to an embodiment of the present invention, the at least one additional heating element comprises at least one microwave radiation generator to generate the electromagnetic radiation and at least one corresponding waveguide coupling the radiation generator to a corresponding opening provided on a cooking compartment surface to guide the electromagnetic radiation into the cooking compartment through the waveguide and the opening.

Advantageously, the barbecue grill further comprises a barbecue control unit configured to drive the at least one microwave radiation generator as a function of food parameters provided by a user.

According to an advantageous embodiment the present invention, the barbecue control unit is configured to control a duty cycle of the at least one microwave radiation generator as a function of the food parameters provided by a user.

Advantageously, said barbecue control unit is configured to set cooking parameters based on the food parameters provided by a user of the barbecue grill, and drive the at least one microwave radiation generator based on the cooking parameters.

According to an embodiment of the present invention the barbecue control unit is adapted to drive also the heating element based on the cooking parameters.

Preferably, said food parameters comprise a food type parameter whose value identifies the type of food to be cooked, and the barbecue control unit further comprises a database module storing for each food type parameter value a corresponding set of cooking parameters.

According to an embodiment of the present invention, said set of cooking parameters corresponding to a food type parameter value comprises:
a base cooking time parameter, whose value determines a base cooking time required to cook the food identified by the food parameter value;
an average power level parameter, whose value determines the average power level of the microwave radiation generated by the microwave radiation generators during the cooking of the food identified by the food parameter value, and
an internal barbecue grill temperature parameter whose value determines the temperature of the cooking compartment required to cook the food identified by the food parameter value.

Preferably, said set of cooking parameters corresponding to a food type parameter value further comprises a unitary cooking time parameter, whose value determines an additional cooking time to be added to the base cooking time based on the weight of the food to be cooked;

According to an embodiment of the present invention, said set of cooking parameters corresponding to a food type parameter value further comprises a starting power level parameter, whose value determines the power level of the microwave radiation generated by the microwave radiation generators at the beginning of the cooking of the food identified by the food parameter value.

According to an advantageous embodiment of the present invention, said food parameters further comprise a total food weight parameter, whose value corresponds to the total weight of the food to be cooked. Said total food weight parameter is advantageously exploited by the barbecue control unit to calculate a total cooking time parameter together with the base cooking time parameter and the unitary cooking time parameter, the barbecue control unit being configured to activate the heating elements and the additional heating elements for a time period corresponding to the total cooking time parameter value.

According to an embodiment of the present invention, the barbecue control unit is configured to calculate the total cooking time parameter by multiplying the unitary cooking time parameter value by the total food weight parameter value, and then by adding the base cooking time parameter to the result of said multiplication.

Preferably, the barbecue control unit is further configured to:
drive the at least one heating element so as to bring the cooking compartment temperature to a value corresponding to the internal barbecue grill temperature parameter value, and
set the power level of the microwave radiation generated by the microwave radiation generators based on the average power level parameter and the starting power level parameter.

Advantageously, the barbecue grill further comprises a grill housing, the grill housing comprising a lower grill housing and a grill hood hingedly connected to the lower grill housing. The cooking compartment is delimited by lateral walls of the lower grill housing and by the grill hood when in a closed position. The openings are preferably provided on at least a lateral wall.

Preferably, the grill hood and the lateral walls are made of metallic material or comprise a covering made of metallic material.

Preferably, the barbecue grill further comprises a metallic wire mesh located in the cooking compartment between the cooking surface and the at least one heating element.

The cooking surface may advantageously comprise a corrugated gridiron provided with alternate crests and troughs.

Alternatively, the cooking surface may comprise a grid having parallel metal bars.

These, and others, features and advantages of the solution according to the present invention will be better understood by reading the following detailed description of some embodiments thereof, provided merely by way of exemplary and non-limitative examples, to be read in conjunction with the attached drawings, wherein:

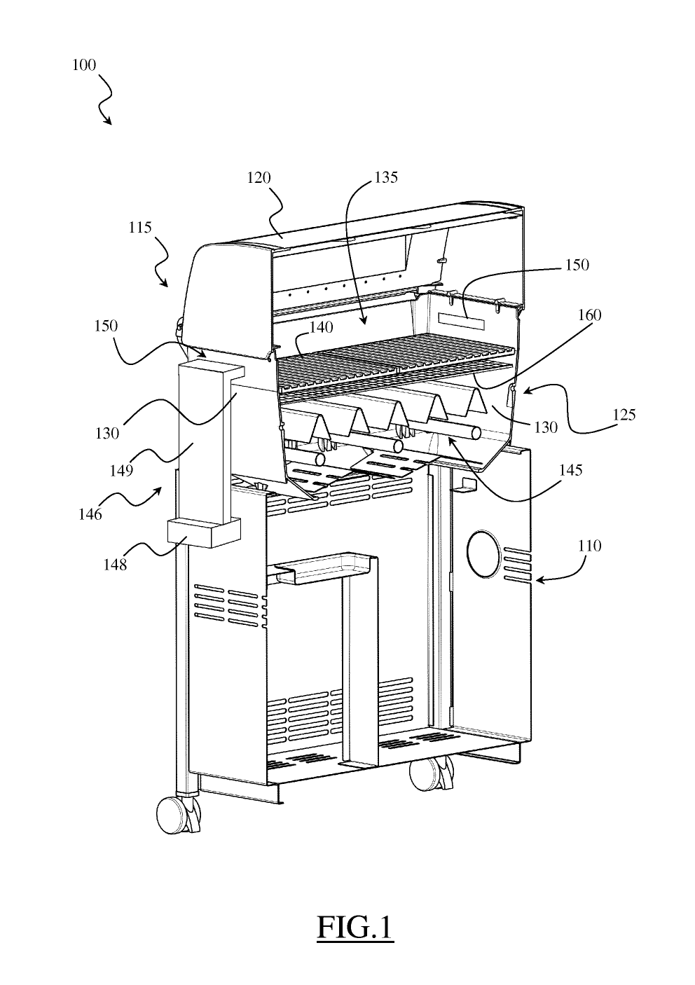

FIG. 1 is a sectional view of a barbecue grill in which embodiments of the present invention may be implemented;

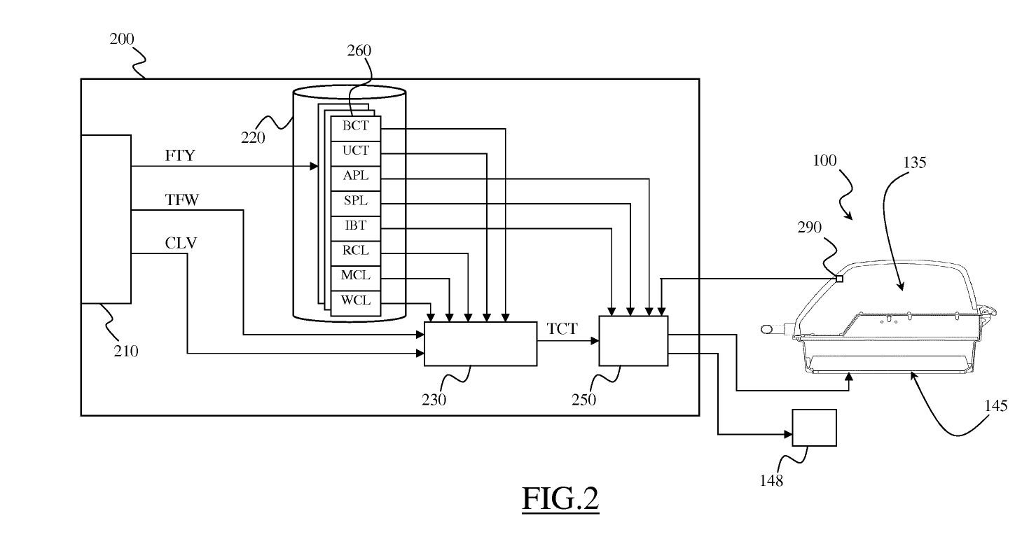

FIG. 2 illustrates in terms of functional modules a grill barbecue control unit of the barbecue grill of FIG. 1 according to an embodiment of the present invention, and

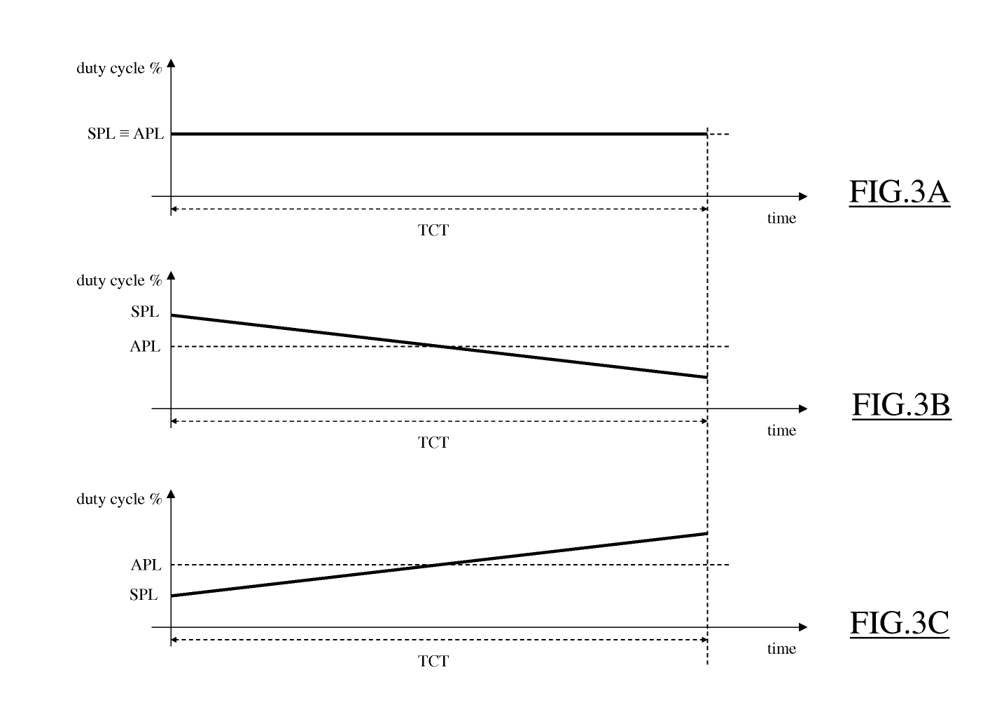

FIGS. 3A-3C are three power modulation profiles of microwave radiation generators of the barbecue grill of FIG. 1 according to an embodiment of the present invention.

With reference to the drawings, FIG. 1 is a sectional view of a barbecue grill 100 in which embodiments of the present invention may be implemented.

The barbecue grill 100 depicted in FIG. 1 is a gas barbecue grill, wherein heat is generated by one or more heating elements 145.

The barbecue grill 100 comprises a stand 110 supporting a grill housing 115. In the exemplary and not limitative barbecue grill 100 illustrated in figure, the stand 110 is a cabinet adapted to house a gas source (not illustrated), such as a gas cylinder, adapted to provide gas to a plurality of gas burners, schematically depicted in figure as tubular elements, defining the heating elements 145. For example, the gas cylinder may store liquid propane. Similar considerations apply in case the barbecue grill 100 is structured in a different way, for example with the grill housing 115 and the stand 110 that form a single body, or with the grill housing 115 and/or the stand 110 that are shaped in a different way.

The grill housing 115 comprises a grill hood 120 and a lower grill housing 125. The grill hood 120 is hingedly connected to the lower grill housing 125 for opening and closing of the barbecue grill 100 during operation. The lower grill housing 125 comprises lateral walls 130 laterally delimiting a cooking compartment 135; when the grill hood 120 is closed, it delimits the cooking compartment 135 from above. Hereinafter, with the term “cooking compartment”, it will be intended both the space itself wherein the food is cooked, as well as the structure defining such space (i.e., the lateral walls 130 and the grill hood 120).

A cooking surface 140 is held within the cooking compartment 135, for example supported by shelf elements located at lateral walls 130 of the cooking compartment 135. In the embodiment at issue, the cooking surface 140 comprises a corrugated gridiron provided with alternate crests and troughs. Similar considerations apply in case the cooking surface 140 is structured in a different way, such as comprising a grid having parallel metal bars.

The heating elements 145 may be located in the lower grill housing 125 under the cooking surface 140, and are adapted to provide heat for cooking food placed on the cooking surface 140. In the example considered, the heating elements 145 comprise three gas burners. The gas burners are supplied with gas coming from the gas source through a hose and valve regulators (not illustrated). The valve regulators are controllable by knobs (not illustrated) allowing to set the amount of gas to be fed to the gas burners.

Naturally, similar considerations apply if the number of gas burners is different, or if the heating elements 145 are of a different type, for example comprising a support—such as a grate or a tray—for white-hot charcoal, or electric heaters. For example, for a cooking surface 140 having a size of 65×50 cm, the power supplied by the heating elements 145 should preferably be equal to at least 12 KW.

In operation, when the grill hood 120 is in an opened configuration, the cooking compartment 135 is accessible, and food may be placed on/taken from the cooking surface 140; when instead the grill hood 120 is in a closed configuration, the cooking compartment 135 is not accessible from the outside, so as to trap the heated air for increasing the internal temperature.

According to an embodiment of the present invention, the cooking speed of the grill barbecue 100 is speeded up and the cooking quality thereof is improved by combining the heat generated by the heating elements 145 with heat generated by means of microwave radiations.

For this purpose, according to an embodiment of the present invention, the grill barbecue 100 comprises one or more additional heating elements 146 adapted to generate electromagnetic radiation in the microwave spectrum—preferably around a frequency of 2.45 GHz—and provide them within the cooking compartment 135. According to an embodiment of the present invention, the additional heating elements 146 comprise at least one microwave radiation generator 148, such as a magnetron capable of irradiating microwave radiations with a power of about 1-2 KW. The actual power level of the microwave radiations is set by modulating the power irradiated by the microwave radiation generators 148 according to a Pulse Width Modulation (PWM) scheme, i.e., by alternatively turning on and off the microwave radiation generators 148 with a variable duty cycle (the duty cycle being the ratio of the duration of the “on” state to the total period of the signal). The higher the duty cycle, the higher the power level of the microwave radiations. Similar considerations apply if the additional heating elements comprise different microwave radiation generators, such as for example solid-state microwave radiation generators. Regarding the period (or control system time base) of the duty cycle, it has been found that an optimal value to drive the microwave radiation generators is about 15 s.

According to an embodiment of the present invention, the microwave radiation generators 148 are located on the stand 110. The microwave radiation generated by the microwave radiation generators 148 is fed to the cooking compartment 135 through waveguides 149, e.g., made of aluminum, which are coupled to openings 150 provided on at least one lateral wall 130 of the lower grill housing 125. In the example at issue, two openings 150 are provided, located on opposite lateral walls 130 of the lower grill housing 125 above the cooking surface 140 in such a way to allow the microwave radiation generated by the microwave radiation generators 148 to propagate in the portion of the cooking compartment 135 located between the grill hood 120 and the cooking surface 140, and to reflect on the lateral walls 130 of the lower grill housing 125 as well as on the walls of the grill hood 120, so as to invest food placed on the cooking surface 140. On this regard, according to an embodiment of the present invention, the grill hood 120 as well as the lateral walls 130 are made of—or comprise coverings or gaskets made of—metallic material, in order to avoid that microwave radiation exits from the grill barbecue 100.

In order to avoid that microwave radiations dangerously mix with gas, a metallic wire mesh 160 may be optionally placed in the cooking compartment 135 between the cooking surface 140 and the heating elements 145. The presence of the metallic wire mesh 160 in combination with the metallic walls (or the metallic coverings) of the grill hood 120 and with the metallic (or the metallic coverings of the) lateral walls 130 of the lower grill housing 125 defines a closed cooking volume adapted to trap the microwave radiation inside therein.

According to an embodiment of the present invention, the grill barbecue 100 comprises a grill barbecue control unit adapted to efficiently set cooking parameters—such as the cooking time, the power irradiated by the microwave radiation generators, and the temperature of the cooking compartment—for optimizing the cooking operations performed by the grill barbecue 100 based on food parameters input by the user—such as the specific type and amount of food to be cooked, as well as the desired degree of cooking. For example, the grill barbecue control unit may be located on a circuit board (not illustrated) located in the barbecue grill 100, such as in the grill housing 115 or in the stand 110.

A grill barbecue control unit 200 according to an embodiment of the present invention is illustrated in FIG. 2 in terms of functional modules.

The grill barbecue control unit 200 comprises an input interface module 210, a database module 220, a cooking time module 230, and a driver module 250.

According to an embodiment of the present invention, the input interface module 210 is adapted to be used by users of the barbecue grill 100 for inputting food parameters describing the food to be cooked by the barbecue grill 100 and the desired way such food has to be cooked. According to an embodiment of the present invention, said food parameters comprise:
A food-type parameter FTY that specifies the type of food to be cooked. The parameter FTY may assume a plurality of values FTY, each one corresponding to a specific type of food, such as: chicken breast, turkey, steak, pork chop, bass, salmon, and so on.
A total food-weight parameter TFW, whose value TFW corresponds to the total weight (for example, in terms of kg) of the food to be cooked.
A cooking level parameter CLV that specifies the desired degree of cooking. The cooking level parameter CLV may assume a plurality of values CLV, each one corresponding to a specific degree of cooking, such as: rare, medium, well done, and so on.

According to an embodiment of the present invention, the input interface module 210 includes knobs, for example a knob per each food parameter. Each knob is capable of being rotated among positions each one corresponding to a specific value of the corresponding food parameter. Different types of input interface module 210 are also contemplated, such as including keyboards, sliders, buttons, touch screens and so on.

According to an embodiment of the present invention, the database module 220 stores for each value FTY the parameter FTY may assume a corresponding cooking parameter table 260 listing a set of cooking parameters for the cooking of the food type identified by such value FTY. According to an embodiment of the present invention, the set of cooking parameters includes:
A base cooking time parameter BCT, whose value BCT represents a base cooking time required to cook the food identified by the parameter FTY. For example, the value BCT of the base cooking time parameter BCT may be expressed in terms of minutes.
A unitary cooking time parameter UCT, whose value UCT represents an additional cooking time to be added to the base cooking time based on the weight of the food to be cooked. For example, the value UCT may be expressed in terms of minutes per each Kg of the food identified by the parameter FTY.
An average power level parameter APL, whose value APL represents the average power level of the microwave radiation generated by the microwave radiation generators 148 during the cooking of the food identified by the parameter FTY. For example, the value APL may be expressed in terms of duty cycle percentage.
A starting power level parameter SPL, whose value SPL represents the power level of the microwave radiation generated by the microwave radiation generators 148 at the beginning of the cooking of the food identified by the parameter FTY. For example, the value SPL may be expressed in terms of duty cycle percentage.
An internal barbecue grill temperature parameter IBT, whose value IBT represents the temperature of the cooking compartment 135 required to cook the food identified by the parameter FTY. For example, the value IBT may be expressed in terms of degrees Celsius.
A rare cooking level parameter RCL, whose value RCL reflects how the cooking time required to cooking the food identified by the parameter FTY has to be modified in order to obtain a rare degree of cooking. For example, the value RCL may be a dimensionless multiplicative parameter.
A medium cooking level parameter MCL, whose value MCL reflects how the cooking time required to cooking the food identified by the parameter FTY has to be modified in order to obtain a medium degree of cooking. For example, the value MCL may be a dimensionless multiplicative parameter.
A well done cooking level parameter WCL, whose value WCL reflects how the cooking time required to cooking the food identified by the parameter FTY has to be modified in order to obtain a well done degree of cooking. For example, the value WCL may be a dimensionless multiplicative parameter.

According to an embodiment of the present invention, the cooking parameter values stored in the cooking parameter tables 260 have been calculated based on physical-chemical characteristics of the food types listed therein.

Three exemplary cooking parameter tables 260 according to an embodiment of the present invention are illustrated hereinbelow:

| | BCT | UCT | APL | SPL | IBT | | | |
|---|---|---|---|---|---|---|---|---|
| FTY | (min) | (min/kg) | (%) | (%) | (° C.) | RCL | MCL | WCL |
| Beef | 5 | 2 | 70 | 80 | 200 | 0.95 | 1 | 1.05 |
| tenderloin | | | | | | | | |
| whole | | | | | | | | |
| Pork chops | 5.3 | 1.74 | 75 | 75 | 210 | 0.94 | 1 | 1.07 |
| Frozen beef | 2.8 | 1.5 | 100 | 100 | 220 | 0.92 | 1 | 1.07 |
| hamburgers | | | | | | | | |

According to an embodiment of the present invention, the cooking time module 230 is configured to calculate a total cooking time parameter TCT whose value TCT represents the total duration, e.g., in terms of minutes, of the operations for cooking the amount identified by the parameter TFW of the food identified by the parameter FTY with the degree of cooking identified by the parameter CLV input by the user through the input interface module 210.

According to an embodiment of the present invention, the cooking time module 230 calculates the value TCT of the parameter TCT according to the following formulas:

if CLV=rare→TCT=(BCT+UCT*TFW)*RCL;

if CLV=medium→TCT=(BCT+UCT*TFW)*MCL;

if CLV=well done→TCT=(BCT+UCT*TFW)*WCL;

wherein BCT, UCT, RCL, MCL, WCL are the values of the cooking parameters BCT, UCT, RCL, MCL, WCL, respectively, listed in the cooking parameter table 260 corresponding to the food type identified by the value FTY of the parameter FTY input by the user, and TFW, CLV are the values of the parameters TFW and CLV input by the user.

For example, making reference to the exemplary cooking parameter table 260 listed above, the value TCT of the total cooking time parameter TCT calculated by the cooking time module 230 for 1.9 kg of beef tenderloin with a well done degree of cooking is equal to:

TCT=(5+2*1.9)*1.05=9.24 minutes

According to an embodiment of the present invention, the driver module 250 is configured to receive the parameter TCT calculated by the cooking time module 230 and the cooking parameters APL, SPL listed in the cooking parameter table 260 corresponding to the food type identified by the value FTY of the parameter FTY input by the user, and to accordingly drive the microwave radiation generators 148 of the barbecue grill 100.

According to an embodiment of the present invention, the driver module 250 activates the microwave radiation generators 148 of the barbecue grill 100 for a time period corresponding to (e.g., equal to) the value TCT of the received parameter TCT, setting the power level of the microwave radiation generators 148 based on the received cooking parameters APL, SPL.

According to an embodiment of the present invention, the driver module 250 is configured to set the power level of the microwave radiation generators 148 in the following way:

1) If the value APL of the average power level parameter APL and the value SPL of the starting power level parameter SPL are equal, the power irradiated by the microwave radiation generators 148 is modulated with a duty cycle percentage equal to APL for the duration of the cooking operations (which are determined by the total cooking time parameter TCT). An example of this power modulation profile is illustrated in FIG. 3A.

2) If the value APL of the average power level parameter APL is lower than the value SPL of the starting power level parameter SPL, the power irradiated by the microwave radiation generators 148 is modulated with a duty cycle percentage starting from the value SPL and linearly decreasing, for the entire duration of the cooking operations, with a slope that guarantees the same total energy that would have been provided by modulating the irradiated power for the entire duration of the cooking operations with a constant duty cycle percentage equal to the value APL. An example of this power modulation profile is illustrated in FIG. 3B.

3) If the value APL of the average power level parameter APL is higher than the value SPL of the starting power level parameter SPL, the power irradiated by the microwave radiation generators 148 is modulated with a duty cycle percentage starting from the value SPL and linearly increasing, for the entire duration of the cooking operations, with a slope that guarantees the same total energy that would have been provided by modulating the irradiated power for the entire duration of the cooking operations with a constant duty cycle percentage equal to the value APL. An example of this power modulation profile is illustrated in FIG. 3C.

According to an embodiment of the present invention, the driver module 250 is further configured to receive—together with the parameters TCT, APL and SPL—also the cooking parameter IBT listed in the cooking parameter table 260 corresponding to the food type identified by the value FTY of the parameter FTY input by the user, and to accordingly drive the heating elements 145 of the barbecue grill 100. According to this embodiment of the invention, the driver module 250 activates the heating elements 145 for a time period corresponding to (e.g., equal to) the value TCT of the received parameter TCT, driving the heating elements 145 to bring the temperature of the cooking compartment 135 of the barbecue grill 100 to a value corresponding to the value IBT of the received internal barbecue grill temperature parameter IBT. This embodiment of the invention is particularly suited for barbecue grills 100 provided with heating elements 145 that are adapted to be automatically controlled, such as for example electric heaters or gas burners fed by means of valve regulators including controllable solenoid valves. According to this embodiment of the invention, in order to allow the temperature of the cooking compartment 135 to be brought, and maintained, to the value IBT of the received internal barbecue grill temperature parameter IBT during the cooking operations, the cooking compartment 135 may be advantageously provided with a temperature sensor 290, such as a thermocouple or a thermistor, coupled to the driver module 250 so as to establish a feedback control loop.

If the heating elements 145 are not adapted to be controlled in an automatic way, such as for example in case of a support for white-hot charcoal or gas burners with valve regulators controllable by knobs, instead of directly driving the heating elements 145, the driver module 250 may be configured to display the value IBT of the internal barbecue grill temperature parameter IBT and/or the value TCT of the total cooking time parameter TCT (for example through a proper display unit, not illustrated in figure), in such a way to allow the user to manually control the heating elements 145 according to said displayed parameter values.

The proposed solution allows to cook food faster than in the known solutions. The Applicant has found that the time required to cook food with the proposed barbecue grill is about 80%-50% of the time required to cook the same food by employing a traditional barbecue grill. Moreover, the proposed barbecue grill is also suited to efficiently cook also large pieces of food.

Naturally, in order to satisfy local and specific requirements, a person skilled in the art may apply to the solution described above many logical and/or physical modifications and alterations.

For example, although in the present description reference has been made to a grill barbecue control unit comprising four distinct modules, i.e., the input interface module, the database module, the cooking time module, and the driver module, some of such modules may be part of a same macro-module. The modules may be implemented by means of electronic units located on the circuit board, and/or may be implemented in form of firmware or software instructions running on corresponding processing units.

Moreover, similar considerations apply if the grill barbecue control unit is configured to carry out a less fine cooking optimization, with only a subset of the cooking parameters stored in the described cooking parameter tables that are exploited for optimizing the cooking operations, such as for example by neglecting the parameters regarding the degree of cooking or by considering only the base cooking parameter, the average power parameter, and the internal barbecue grill temperature parameter.

According to another possible embodiment, the driver module 250 can be configured to drive only the microwave radiation generators 148 based on cooking parameters. In particular, it can be designed only to set the power level of the microwave radiation generator 148 based on the above mentioned cooking parameters APL and SPL, with no control on the other heating elements.

1. A barbecue grill (100) comprising:
a cooking compartment (135);
a cooking surface (140) located in the cooking compartment;
at least one heating element (145) located under the cooking surface and adapted to be operated to provide heat for cooking food placed on the coking surface,
characterized in that the barbecue grill further comprises:
at least one additional heating element (146) adapted to generate electromagnetic radiation in the microwave spectrum and feed said electromagnetic radiation into the cooking compartment for investing food placed on the coking surface.

2. The barbecue grill (100) of claim 1, wherein the at least one heating element (145) is adapted to generate heat from a solid fuel, a gas fuel or an electric current.

3. The barbecue grill (100) of claim 1 or 2, wherein the at least one additional heating element (146) comprises at least one microwave radiation generator (148) to generate the electromagnetic radiation and at least one corresponding waveguide (149) coupling the radiation generator to a corresponding opening (150) provided on a cooking compartment (135) surface to guide the electromagnetic radiation into the cooking compartment (135) through the waveguide and the opening (150).

4. The barbecue grill (100) of claim 3, further comprising a barbecue control unit (200) configured to drive the at least one microwave radiation generator (148) as a function of food parameters (FTY, TFW, CLV) provided by a user.

5. The barbecue grill (100) of claim 4, wherein the barbecue control unit (200) is configured to control a duty cycle of the at least one microwave radiation generator (148) as a function of the food parameters (FTY, TFW, CLV) provided by a user.

6. The barbecue grill (100) of claim 5, wherein the barbecue control unit (200) is configured to:
set cooking parameters (BCT, UCT, APL, SPL, IBT, RCL, MCL, WCL, TCT) based on the food parameters (FTY, TFW, CLV) provided by a user of the barbecue grill (100), and
drive the at least one microwave radiation generator (148) based on the cooking parameters.

7. The barbecue grill (100) of claim 6, wherein the barbecue control unit (200) is adapted to drive also the heating element (145) based on the cooking parameters.

8. The barbecue grill (100) of claim 4 wherein said food parameters comprise a food type parameter (FTY) whose value identifies the type of food to be cooked, the barbecue control unit (200) further comprising a database module (220) storing for each food type parameter (FTY) value a corresponding set of cooking parameters.

9. The barbecue grill (100) of claim 8, wherein said set of cooking parameters corresponding to a food type parameter (FTY) value comprises:
a base cooking time parameter (BCT), whose value determines a base cooking time required to cook the food identified by the food parameter (FTY) value;
an average power level parameter (APL), whose value determines the average power level of the microwave radiation generated by the microwave radiation generators (148) during the cooking of the food identified by the food parameter (FTY) value, and
an internal barbecue grill temperature parameter (IBT) whose value determines the temperature of the cooking compartment (135) required to cook the food identified by the food parameter (FTY) value.

10. The barbecue grill (100) of claim 9, wherein said set of cooking parameters corresponding to a food type parameter (FTY) value further comprises:
a unitary cooking time parameter (UCT), whose value determines an additional cooking time to be added to the base cooking time based on the weight of the food to be cooked.

11. The barbecue grill (100) of claim 9 or 10, wherein said set of cooking parameters corresponding to a food type parameter (FTY) value further comprises a starting power level parameter (SPL), whose value determines the power level of the microwave radiation generated by the microwave radiation generators (148) at the beginning of the cooking of the food identified by the food parameter (FTY) value.

12. The barbecue grill (100) of claim 10, wherein said food parameters further comprise a total food weight parameter (TFW), whose value corresponds to the total weight of the food to be cooked, the barbecue control unit (200) being configured to:
calculate a total cooking time parameter (TCT) based on the base cooking time parameter (BCT), the unitary cooking time parameter (UCT) and the total food weight parameter (TFW);
activate the heating elements (145) and the additional heating elements (146) for a time period corresponding to the total cooking time parameter (TCT) value.

13. The barbecue grill (100) of claim 12, wherein the barbecue control unit (200) is configured to calculate the total cooking time parameter (TCT) by multiplying the unitary cooking time parameter (UCT) value by the total food weight parameter (TFW) value, and then by adding the base cooking time parameter (BCT) to the result of said multiplication.

14. The barbecue grill (100) of claim 9, wherein the barbecue control unit (200) is further configured to:
drive the at least one heating element (145) so as to bring the cooking compartment (135) temperature to a value corresponding to the internal barbecue grill temperature parameter (MT) value, and
set the power level of the microwave radiation generated by the microwave radiation generators (148) based on the average power level parameter (APL) and the starting power level parameter (SPL).

15. The barbecue grill (100) of claim 1, further comprising a grill housing (115), the grill housing (115) comprising a lower grill housing (125) and a grill hood (120) hingedly connected to the lower grill housing (125), the cooking compartment (135) being delimited by lateral walls (135) of the lower grill housing (125) and by the grill hood (120) when in a closed position, wherein the openings (150) are provided on at least a lateral wall (135).
